(19) United States
(12) Patent Application Publication
(10) Pub. No.: US 2023/0387743 A1
(43) Pub. Date: Nov. 30, 2023

(54) ELECTRICAL DRIVE UNIT

(71) Applicant: Rolls-Royce Deutschland Ltd & Co KG, Blankenfelde-Mahlow (DE)

(72) Inventors: Lukas SOBOTTA, Erlangen (DE); Jan Magnus FARSTAD, Trondheim (NO); Maria BØE, Trondheim (NO); Niklas SCHAMBERGER, Nürnberg (DE)

(21) Appl. No.: 18/203,409

(22) Filed: May 30, 2023

(30) Foreign Application Priority Data
May 31, 2022 (DE) 10 2022 113 635.3

(51) Int. Cl. H02K 3/50; H02K 11/33

(52) U.S. Cl. CPC H02K 3/50; H02K 11/33; H02K 2203/03

(57) ABSTRACT

An electric drive unit includes a three-phase motor having a rotor, a stator, and a motor housing, wherein the stator has three coil windings that each include one winding wire having two coil connectors. The electric drive unit further includes a converter that provides the three-phase motor with a three-phase alternating current and has three terminal contacts. The coil connectors are connected to the terminal contacts by way of a star circuit or a delta circuit. The converter is implemented in a circuit board assembly having at least one circuit board. The terminal contacts of the converter are on the circuit board, and the connections, provided in the context of the star circuit or delta circuit, between the coil connectors and the terminal contacts of the converter, are implemented in that the respective ends of the winding wires of the coil windings are connected directly to the circuit board.

The present patent document claims the benefit of German Patent Application No. 10 2022 113 635.3, filed May 31, 2022, which is hereby incorporated by reference in its entirety.

### TECHNICAL FIELD

The disclosure relates to an electric drive unit.

### BACKGROUND

In three-phase motors, it is known to implement three coil windings in the stator, the winding wires of the coil windings may be referred to as U, V, W, and the coil windings have terminal clamps at their ends. The terminal clamps are connected to a three-phase current by way of a star circuit or a delta circuit, wherein the three-phase current have three current-conducting conductors L1, L2, L3. The wiring of the coil windings to form a star circuit or a delta circuit takes place in a terminal block. The latter is located in an electrical junction box which is disposed on the motor housing.

For example, the three-phase current may be provided by a three-phase converter, (e.g., a three-phase inverter), which converts a DC voltage provided by a battery into a three-phase current.

The described construction requires numerous cables between the terminal clamps of the coil windings, the connectors of the current-conducting conductors and the connectors of a converter.

### SUMMARY

The present disclosure is based on the object of providing effective electrical contacting of the coil windings of a three-phase motor.

The scope of the present disclosure is defined solely by the appended claims and is not affected to any degree by the statements within this summary. The present embodiments may obviate one or more of the drawbacks or limitations in the related art.

Accordingly, an electric drive unit is disclosed. The electric drive unit has a three-phase motor that includes a rotor, a stator, and a motor housing. The stator has three coil windings, wherein each coil winding includes one winding wire having two coil connectors. The electric drive unit furthermore includes a converter configured to provide the three-phase motor with a three-phase alternating current and, to this end, has three terminal contacts. The coil connectors here are connected to the terminal contacts by way of a star circuit or a delta circuit.

The converter is implemented in a circuit board assembly having at least one circuit board, wherein the terminal contacts of the converter are configured on the circuit board, and the connections, which are to be provided in the context of the star circuit or delta circuit, between the coil connectors and the terminal contacts of the converter are implemented in that the respective ends of the winding wires of the coil windings are connected directly to the circuit board.

The disclosure is based on the concept of configuring the converter in a circuit board assembly and thereby connecting the coil connectors directly to the circuit board, without using a separate junction box, wherein the ends of the winding wires contact the circuit board directly. As a result of the omission of a separate junction box and wiring to be implemented in the latter, the overall wiring complexity is reduced and an electrical connection between the terminal contacts of the converter and the coil contacts of the three-phase motor is established in a simple manner. In the process, the disadvantages associated with the use of a separate junction box are dispensed with, (e.g., contact resistances in the connectors of the junction box which have to be taken into account and any required thermal management of the contacts in the junction box).

Three coil connectors are connected to a common star point in the case of a star circuit, while the three other coil connectors are each connected to one terminal contact of the converter. The three strands of windings thus converge at the star point on the one side. In the case of a delta circuit, connectors of the three strands of windings are connected to one another in the form of a triangle. The corners of the triangle are connected to the three phases or terminal contacts of the converter. In both cases, there are three coil connectors that are each connected to one terminal contact of the converter.

The described solution implies that the winding wires which for contacting protrude from the electric motor have a length and thickness of such a type that the protruding ends are suitable for being connected directly to connectors on the circuit board.

To this end, one embodiment provides that the ends of the winding wires are each provided with connectors in the form of terminal lugs which are fixedly screwed directly to or plugged directly into terminals of the circuit board. In one embodiment, the winding wire is in each case configured as a stranded wire, and the terminal lug is crimped directly onto the end of the winding wire. This takes place by using crimping pliers. Alternatively, the winding wire is in each case configured as a solid conductor (e.g., a single wire), for example, as a flat copper conductor, and the terminal lug is crimped directly onto the end of the winding wire. The winding wire of the coil winding is thus routed directly to the respective terminal on the circuit board and provided with a terminal lug at the terminal.

An alternative embodiment provides that the ends of the winding wires are each provided with connectors which form a threaded bore, wherein the connectors by way of screws are fixedly screwed directly to terminals of the circuit board. One embodiment here provides that the winding wire is in each case configured as a stranded wire, and one end of the connector is crimped directly onto the end of the winding wire. Alternatively, it may be provided that the winding wire is in each case configured as a solid conductor, and one end of the connector is crimped directly onto the end of the winding wire. The winding wire of the coil winding is thus routed directly to the respective terminal on the circuit board and there, by way of a connector which is screwed to the circuit board, connected to a terminal of the circuit board.

It may be provided in a further embodiment that the winding wire per se forms fastening structures which permit the winding wire to be connected to the terminal on the circuit board without any additional terminal lug or connector having to be used. To this end, it may be provided that a single-wire winding wire, at the end thereof, is pressed flat and provided with a bore so that the winding wire may be screwed directly to a terminal of the circuit board.

In this way, the winding wire may be connected to the circuit board with a connector, or directly without a connector.

A further embodiment provides that the circuit board assembly that forms the converter is disposed in or on the three-phase motor. A compact assembly is provided as a result, making it possible for the winding wires of the coil windings to potentially be of a short length. To this end, one design embodiment provides that the circuit board assembly is disposed in or on the motor housing. For example, it may be provided that the circuit board assembly is disposed on the external side of the motor housing.

The term “motor housing” is to be understood in a wide sense in the context of the present disclosure. A housing which is fixedly connected to the actual motor housing may also be understood to be a motor housing. For example, it may be provided that the circuit board assembly which forms the converter is implemented in or on a dedicated converter housing, the latter forming an extension of the motor housing and being fixedly connected thereto.

A further embodiment of the disclosure provides that the terminal contacts of the converter on the circuit board are configured as contact pads, and the ends of the winding wires contact the contact pads directly. In this way, the coil connectors thus directly contact terminal contacts that are configured in the form of contact pads on the circuit board.

The converter may be an inverter configured to convert a DC voltage provided by a battery into a three-phase current.

The three-phase motor may be of any arbitrary construction. In certain embodiments, the three-phase motor is a permanent magnet synchronous motor. In the case of a permanent magnet synchronous motor, the stator is occupied by coils, while surface magnets are attached to the rotor.

The disclosure is explained in more detail hereunder with reference to the figures of the drawing by a plurality of exemplary embodiments.

### BRIEF DESCRIPTION OF THE DRAWINGS

FIG. 1 schematically shows an exemplary embodiment of an electric drive unit having a three-phase motor and a circuit board on which an inverter is implemented, wherein winding wires of the three-phase motor contact terminal contacts of the inverter directly on the circuit board;

FIG. 2 shows the exemplary embodiment of FIG. 1 while additionally illustrating components of the three-phase motor;

FIG. 3 shows an exemplary embodiment corresponding to that of FIG. 2, in which a connection between the winding wires and the circuit board is performed on the upper side of the circuit board;

FIG. 4 shows a further exemplary embodiment of an electric drive unit having a three-phase motor and a circuit board on which an inverter is implemented, wherein winding wires of the three-phase motor contact terminal contacts of the inverter directly on the circuit board while using connectors with an integrated threaded bore;

FIG. 5 shows an exemplary embodiment of a connector with an integrated threaded bore according to FIG. 4 in an enlarged illustration;

FIG. 6 schematically shows the contacting of the coils of a three-phase motor according to the prior art;

FIG. 7 shows a star circuit and a bridge circuit according to the prior art; and

FIG. 8 schematically shows a terminal block having coil connectors according to the prior art, which are wired according to a star circuit or according to a bridge circuit.

### DETAILED DESCRIPTION

In order to better understand the background to the present disclosure, the contacting of coils of a three-phase motor with a three-phase current according to the prior art is first described by FIGS. 6 to 8.

According to FIG. 6, a three-phase motor 1 includes a three-phase winding system which is provided by three coil windings that may be referred to as U, V, W and at the ends thereof form terminal clamps U1, V1, W2 and U2, V2, W2. In order for the coil windings to be supplied with current, the coil windings U, V, W are connected to a three-phase current supply (three-phase current) which provides a phase-shifted, three-phase voltage signal.

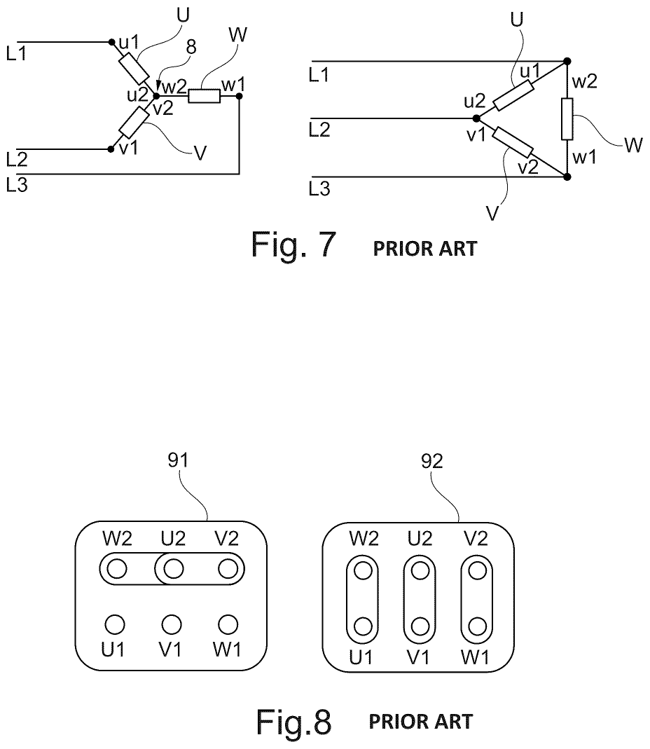

The coil windings here are connected to a three-phase current by way of a star circuit or by way of a delta circuit, wherein the three-phase current have three current-conducting conductors L1, L2, L3, which are also referred to as external conductors. Such a star circuit and a delta circuit are known per se and illustrated in FIG. 7. The illustration on the left in FIG. 7 shows the star circuit, and the illustration on the right in FIG. 7 shows the delta circuit, wherein, in each case, three coil windings U, V, W which at the ends thereof each form two coil connectors U1, U2, V1, V2, W1, W2.

In the case of the star circuit, the coil connectors U2, V2, and W2 are wired to one another at a star point 8. The three current-conducting conductors L1, L2, L3 are connected as follows: L1 to U1, L2 to V1, and L3 to W1. In the case of the delta circuit, the coil connectors U1, W2, and V1, U2, and V2, W1 are wired to one another so that there are likewise three connectors which are connected to the conductors L1, L2, L3.

The wiring of the coil windings U, V, W to form a star circuit or a delta circuit takes place in a terminal block. Such a terminal block is illustrated in FIG. 8. Illustrated on the left here is a terminal block 91, the connectors of which are connected to form a star circuit. Illustrated on the right is a terminal block 92, the connectors of which are connected to form a delta circuit.

Reverting to FIG. 7, the three-phase motor 1 in a manner known per se has a rotor (not illustrated), a stator 12, and a motor housing 13. A terminal block according to FIG. 8, conjointly with the associated connectors, is disposed in an electrical junction box 7 which is configured on the motor housing 13. The junction box 7 thus connects the coil windings to the current-conducting conductors. Implemented in FIG. 6 is a star circuit in which the coil connectors V2, U2, W2 are wired to one another at the star point 8.

The current-conducting conductors L1, L2, L3 are provided by a converter, for example an inverter. A connection between the junction box 7 (e.g., the motor input) and the output of such a converter is provided here by a cable connection 71.

The known assembly requires numerous cable connections and the provision of a terminal block in a connection unit on the motor housing.

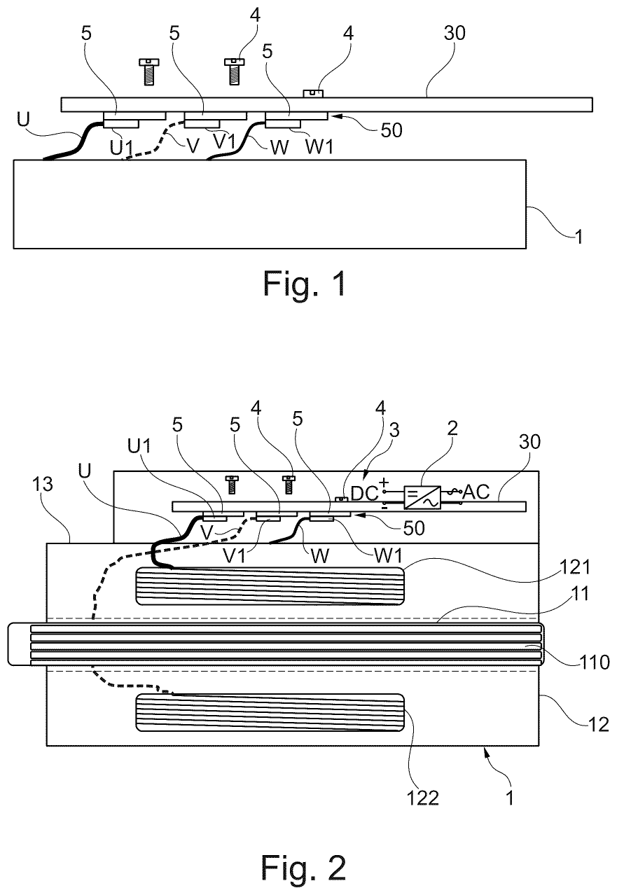

FIG. 1 schematically shows an exemplary embodiment of an electric drive unit in which the coil connectors of the coil windings are connected directly, e.g., without interposition of a junction box, to a circuit board assembly on which a converter is implemented.

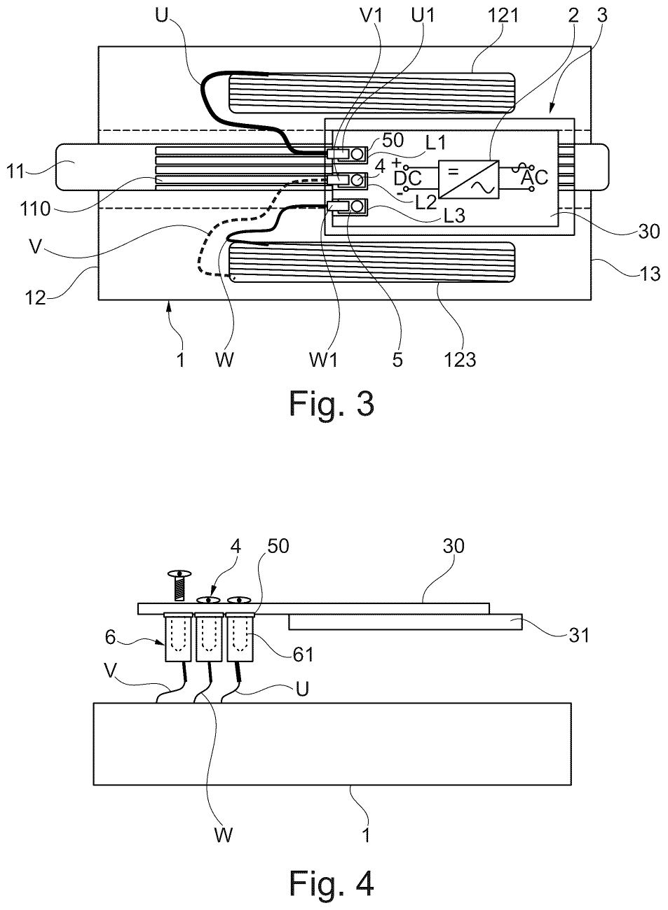

The three-phase motor 1 in FIG. 1 is only schematic and illustrated as a block. The coil windings, which are each formed from one winding wire U, V, W, form free ends which protrude from the motor 1 and extend in the direction of a circuit board 30. The circuit board 30 forms part, or is part, of a circuit board assembly which implements a converter, as will yet be explained by FIGS. 2 and 3. Each winding wire U, V, W at the end thereof forms a contact or coil connector U1, V1, W1, respectively. The coil connectors U1, V1, W1 are connected directly to the circuit board 30. To this end, the coil connectors U1, V1, W1 are connected to connectors in the form of terminal lugs 5. The terminal lugs 5 are screwed, by screws 4, to contact pads or contact faces 50, which are configured on the lower side of the circuit board 30. In this way, direct contacting of the winding wires U, V, W and contact faces 50 of the circuit board 30 is provided by way of the terminal lugs 5 and the screws 4.

FIG. 2 shows an exemplary embodiment of the assembly of FIG. 1, with additional details being illustrated. The three-phase motor 1 includes a rotor 11, a stator 12, and a motor housing 13. The three-phase motor 1 in the exemplary embodiment illustrated is configured as a permanent magnet synchronous motor so that the rotor 11 configures surface magnets 110. The stator 12 includes three coils or coil windings, of which two coil windings 121, 122 may be seen in FIG. 2. Each coil winding is formed by one of the winding wires U, V, W. The winding wires U, V, W here extend from the motor housing 13 in the direction of the circuit board 30.

It may furthermore be seen in FIG. 2 that the circuit board 30 is a component part of a circuit board assembly 3 that implements a converter 2, (e.g., an inverter in the exemplary embodiment illustrated), which converts a direct current into a three-phase alternating current or three-phase current. The circuit board assembly 3 may include one circuit board 30, as illustrated, or alternatively a plurality of circuit boards. The circuit board assembly 3 with the converter 2 here is disposed directly on the three-phase motor 1. In the exemplary embodiment discussed, the circuit board assembly is disposed directly on the external side of the motor housing 13.

The converter 2 is thus implemented by the circuit board assembly 3. The terminal contacts L1, L2, L3 for the three phases of the converter 2 are correspondingly provided on the circuit board 10. The terminal contacts L1, L2, L3 here are provided on the contact pads 50 which represent the output (OUT) of the converter. The contacting of the terminal contacts L1, L2, L3 or of the contact pads 50 by the winding wires U, V, W takes place directly, as has been described in the context of FIG. 1.

The connection of the coil connectors to the terminal contacts may better be seen in the illustration of FIG. 3, wherein FIG. 3 depicts the circuit board assembly 3 with the circuit board 30 in an illustration from above. FIG. 3 shows a slight modification of the design embodiment in FIG. 2 to the extent that the terminal contacts of the converter are configured on the upper side of the circuit board 30 (and not on the lower side as in FIG. 2). Both variants are possible.

In FIG. 3, it is in particular possible to see the three contact pads 50 which provide the three terminal contacts L1, L2, L3 of the converter 2 for the three-phase alternating current, and the terminal lugs 5 which are configured on the coil connectors U1, V1, W1 of the winding wires U, V, W and by way of screws 4 are screwed directly onto the contact pads 50.

The contacting of the terminal contacts L1, L2, L3 by the coil connectors U1, V1, W1 in FIGS. 1 to 3 takes place by way of a star circuit, corresponding to the illustration on the left in FIG. 7. Alternatively, the contacting may also take place by way of a bridge circuit, corresponding to the illustration on the right in FIG. 7, wherein in this case the illustrated coil connectors U1, V1, W1 are each connected to one further coil connector W2, U2, V2.

The winding wires U, V, W may be winding wires in the form of a stranded wire or in the form of a solid conductor, for example, a flat copper conductor. The terminal lug 5 is in each case crimped onto the end of the winding wire U, V, W. The end of the winding wire U, V, W here has a diameter of such a type that the terminal lug 5 may be crimped onto the former.

FIG. 4 shows a modification of the electric drive unit of FIGS. 1 to 3, in which the ends of the winding wires are connected to the circuit board 30 by connectors 6. The assembly of FIG. 4 otherwise corresponds to the assembly of FIGS. 1 to 3. Schematically illustrated additionally here is a holding structure 31 that holds the circuit board 30. The holding structure 31 is, for example, the motor housing of the three-phase motor 1 or a structure configured on or connected to the motor housing.

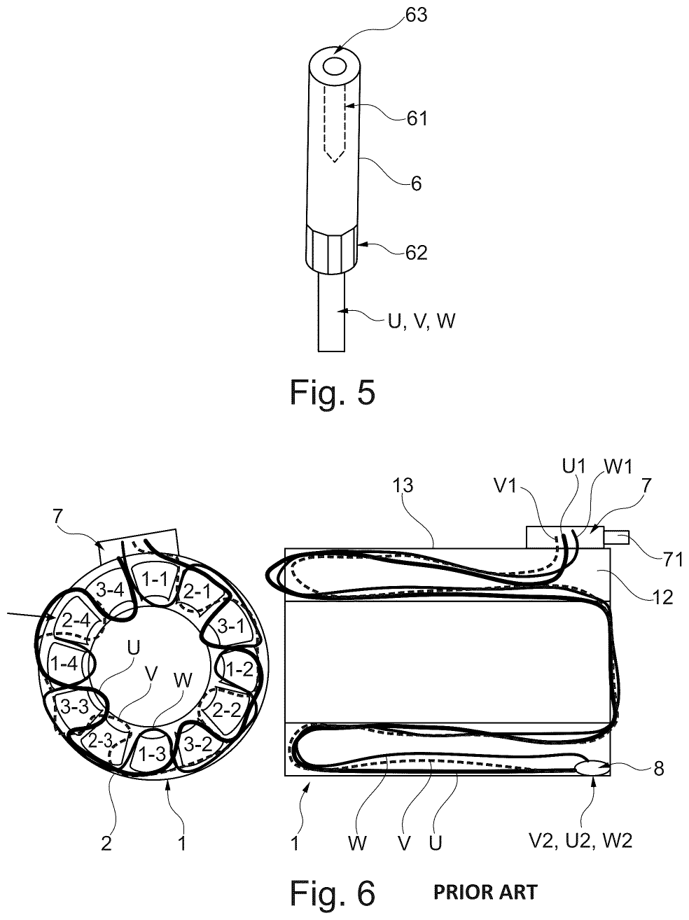

The connectors 6 of FIG. 4 are separately illustrated in FIG. 5. Accordingly, the connectors 6 are of cylindrical configuration. The connectors at the lower end thereof include a crimped region 62 that is crimped onto the end of the respective winding wire U, V, W. The connectors, at the end thereof that faces away from the winding wire, furthermore include a threaded bore 61 that permits the connector 6 to be screwed to the circuit board 30 in a perpendicular orientation by screws 4, as is illustrated in FIG. 4. That end-face end of the cylindrical connector that faces away from the winding wire forms a contact region 63, which is placed directly onto a contact pad 50 of the circuit board 30, wherein the total of three contact pads 50 form the terminal contacts L1, L2, L3 of a converter, as has been explained.

It is understood that the disclosure is not restricted to the embodiments described above, and various modifications and improvements may be undertaken without departing from the concepts described here. For example, the converter may alternatively be configured as an inverter if the used current source provides an alternating current. It is also pointed out that the schematically illustrated construction of the three-phase motor is to be understood to be purely exemplary. In principle, the disclosure may be implemented on any arbitrary three-phase motor.

It is furthermore pointed out that any of the features described may be used separately or in combination with any other features, to the extent that the features are not mutually exclusive. The disclosure extends to and includes all combinations and sub-combinations of one or more features which are described here. If ranges are defined, the ranges thus include all of the values within the ranges as well as all of the partial ranges that lie within a range.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

1. An electric drive unit comprising:
a three-phase motor comprising a rotor, a stator, and a motor housing, wherein the stator has three coil windings, wherein each coil winding of the three coil windings comprises one winding wire having two coil connectors; and
a converter configured to provide the three-phase motor with a three-phase alternating current, wherein the converter has three terminal contacts,
wherein the coil connectors of the three coil windings are connected to the terminal contacts of the converter by way of a star circuit or a delta circuit,
wherein the converter is implemented in a circuit board assembly having at least one circuit board,
wherein the terminal contacts of the converter are configured on the circuit board, and
wherein connections between the coil connectors of the three coil windings and the terminal contacts of the converter are implemented in that respective ends of the winding wires of the coil windings are connected directly to the circuit board.

2. The electric drive unit of claim 1, wherein each end of the winding wires is provided with a connector in a form of a terminal lug that is fixedly screwed directly to or plugged directly into a terminal of the circuit board.

3. The electric drive unit of claim 2, wherein each winding wire is configured as a stranded wire or a solid conductor, and
wherein the terminal lug is crimped onto an end of a respective winding wire.

4. The electric drive unit of claim 1, wherein the ends of the winding wires are each connected to connectors that form a threaded bore, and
wherein the connectors are fixedly screwed directly to terminals of the circuit board by screws.

5. The electric drive unit of claim 4, wherein each winding wire is configured as a stranded wire or a solid conductor, and
wherein one end of a respective connector is crimped directly onto an end of a respective winding wire.

6. The electric drive unit of claim 1, wherein the circuit board assembly is disposed in or on the three-phase motor.

7. The electric drive unit of claim 6, wherein the circuit board assembly is disposed in or on the motor housing of the three-phase motor.

8. The electric drive unit of claim 7, wherein the circuit board assembly is connected to an external side of the motor housing.

9. The electric drive unit of claim 1, wherein the terminal contacts of the converter on the circuit board are configured as contact pads, and
wherein the ends of the winding wires contact the contact pads directly.

10. The electric drive unit of claim 1, wherein the converter is an inverter.
